(19) United States
(12) Patent Application Publication
(10) Pub. No.: US 2014/0358748 A1
(43) Pub. Date: Dec. 4, 2014

(54) CONTENT BASED PAYROLL COMPLIANCE SYSTEM

(71) Applicant: Intuit Inc., Mountain View, CA (US)

(72) Inventors: Steve G. Goyette, Vancouver (CA); Yogish Pai, Mountain View, CA (US); Robert Bruce MacMartin, Vancouver (CA)

(21) Appl. No.: 13/906,202

(22) Filed: May 30, 2013

(51) Int. Cl. G06Q 40/00; G06Q 30/00

(52) U.S. Cl. CPC G06Q 40/125; G06Q 30/018
USPC 705/32

(57) ABSTRACT

Payroll jurisdiction metadata for a region is obtained and provided to a payroll calculation source, the payroll calculation source having access to payroll jurisdiction metadata associated with one or more regions. Company and employee data for a company and one or more employees associated with the company is then obtained and provided to a company and employee data source. The payroll jurisdiction metadata for the region and the company and employee data for the company are then provided to a payroll engine where the company and employee data for the company is transformed into regional payroll data for the company for the region using the payroll jurisdiction metadata for the region. The regional payroll data for the company for the region is provided to a financial management system.

### BACKGROUND

The accurate calculation and running of payroll is a critical function for any business; not only for accounting and employee morale reasons, but also to ensure the company, and its employees, are in compliance with the ever growing and changing laws associated with payroll, payroll taxes, withholdings, and record keeping.

Several financial management systems are currently available to help companies automatically/semi-automatically create a payroll system and “run”, i.e., calculate, a payroll. However, each region, such as a city, county, state, country, or other political grouping, typically has its own regulations and requirements regarding the operation and running of a payroll. In addition, the rules and regulations regarding payroll, such as mandatory withholdings, tax rates, tax exempt, and non-tax exempt, income and programs, within a given region often change, with significant regularity and with significant effects on payroll operation and any given payroll run.

This situation creates a longstanding problem for providers of financial management systems, such as payroll systems, because it is almost impossible, and certainly impractical, to create a payroll “engine”, e.g., a payroll calculation module, that can take into account the rules and regulations for every region. In addition, even if a payroll engine were created to take into account even a fraction of the rules and regulations for multiple regions, when the rules and regulations for one of the regions change, which as noted above happens frequently within even a single region, the payroll engine created at such significant expense would then have to be re-created, or modified, and then re-distributed out to the users.

This represents a significant burden not only for the payroll system provider, but also for the users of the payroll system who would have to wait for the updated/latest version of the payroll system for their region and also constantly ensure they were indeed running the latest version. To try and address this problem, financial management system providers, e.g., payroll system providers, often create multiple versions of their product with each version optimized for a defined region. However, this is, at best, a partial solution for at least two reasons.

First, it is not practical for the payroll system providers to make a dedicated version of their payroll systems for each region. Consequently, for some regions a dedicated regional payroll system is simply not available and must be created, via local modification, by individual users in a region. However, even in regions where a payroll system optimized to that region is available, frequent rule and regulation changes within the region are still an issue. Consequently, the payroll system must still be frequently re-created, or modified, and then distributed out to the users. Again this represents a significant burden not only for the payroll system provider, but also for the users of the payroll system who have to wait for the updated/latest version of the payroll system for their region and constantly ensure they are running the latest version.

To make matters worse, the number of companies that operate with locations in multiple regions is growing almost exponentially each year. Consequently, these potential users of payroll systems have a greater and greater need for a payroll system that is, or can be, optimized to multiple regions. However, as noted above, currently, payroll systems cannot provide this capability in an efficient, economical, or even practical way.

What is needed is a method and system for providing a payroll system and payroll engine that can be easily and efficiently optimized to run accurate and compliant payroll in multiple regions, i.e., allows for the addition of new regions as well as updating and maintaining existing regions, without having to recompile or redeploy a codebase or fundamentally change the payroll application as implemented/accessed by the individual users of the payroll application.

### SUMMARY

In accordance with one embodiment, a content based payroll compliance system is provided by obtaining payroll jurisdiction metadata for a region and providing the payroll jurisdiction metadata for the region to a payroll calculation source, the payroll calculation source having access to payroll jurisdiction metadata associated with one or more regions. In one embodiment, company and employee data for a company and one or more employees associated with the company is then obtained and provided to a company and employee data source. In one embodiment, the payroll jurisdiction metadata for the region from the payroll calculation source and the company and employee data for the company from the company and employee data source is provided to a payroll engine where the company and employee data for the company is transformed into regional payroll data for the company for the region using the payroll jurisdiction metadata for the region. In one embodiment, the regional payroll data for the company for the region is provided to a financial management system.

### BRIEF DESCRIPTION OF THE DRAWINGS

FIG. 1A is a block diagram of an exemplary architecture for implementing one embodiment;

FIG. 1B shows a payroll jurisdiction metadata format for a region 1 in accordance with one specific illustrative example of one embodiment;

FIG. 1C shows a company and employee data format for a company A in accordance with one specific illustrative example of one embodiment;

FIG. 2 is a flow chart depicting a process for providing a content based payroll compliance system in accordance with one embodiment;

FIG. 3A shows an exemplary tax table in accordance with one specific illustrative example of one embodiment;

FIG. 3B shows the codification of the tax table of FIG. 3A in accordance with one specific illustrative example of one embodiment;

FIG. 4A shows the code format of a constant for superannuation in the region of Australia in accordance with one specific illustrative example of one embodiment;

FIG. 4B shows the codified constant of FIG. 4A referenced by name in a calculation function performed by the calculation execution files in accordance with one specific illustrative example of one embodiment;

FIG. 5A shows codified Tax File Number Declaration in accordance with one specific illustrative example of one embodiment;

FIG. 5B shows what the codified form of FIG. 5A looks like for a fictional user with data in accordance with one specific illustrative example of one embodiment;

FIG. 6 shows an illustrative example of a codified wage item, superannuation, with the phase “pretax” in accordance with one specific illustrative example of one embodiment;

FIG. 7 shows the codification of the function superannuation with the parameter gross pay in accordance with one specific illustrative example of one embodiment;

FIG. 8 shows company data codified in accordance with one specific illustrative example of one embodiment;

FIG. 9 shows codified employee data in accordance with one specific illustrative example of one embodiment;

FIG. 10A is a flow chart showing one illustrative example of a process 1000 for generating the regional payroll data, i.e., running the regionally optimized payroll, for the company in accordance with one specific illustrative example of one embodiment; and [0024] FIG. 10B shows a resultant codified paystub generated in accordance with one specific illustrative example of one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a system and method for providing a content based payroll compliance system includes a process for providing a content based payroll compliance system implemented by one or more processors associated with one or more computing systems.

As used herein, the term “computing system”, includes, but is not limited to, a desktop computing system; a portable computing system; a mobile computing system; a laptop computing system; a notebook computing system; a tablet computing system; a workstation; a server computing system; a mobile phone; a smart phone; a wireless telephone; a two-way pager; a Personal Digital Assistant (PDA); a media player, i.e., an MP3 player and/or other music and/or video player; an Internet appliance; or any device that includes components that can execute all, or part, of any one of the processes and/or operations as described herein.

In addition, as used herein, the term computing system, can denote, but is not limited to, systems made up of multiple desktop computing systems; portable computing systems; mobile computing systems; laptop computing systems; notebook computing systems; tablet computing systems; workstations; server computing systems; smart phones; wireless telephones; two-way pagers; Personal Digital Assistants (PDAs); media players; Internet appliances; or any devices that can be used to perform the processes and/or operations as described herein.

In one embodiment, one or more computing systems are connected by one or more communications channels, such as, but not limited to: any general network, communications network, or general network/communications network system; a cellular network; a wireless network; a combination of different network types; a public network; a private network; a satellite network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

In accordance with one embodiment, the process for providing a content based payroll compliance system is part of, linked to, or otherwise associated with, one or more financial management systems used by one or more of the one or more individuals.

Herein the terms “individual” and “user” are used interchangeably and include, but are not limited to, any individual party and/or entity as discussed herein, and/or as defined in the art at the time of filing, and/or as defined after the time of filing.

Herein the term “region” includes any entity or place that has the power to dictate rules, regulations, taxes, or other criteria that have an effect on payroll calculations, or must be taken into consideration when running a payroll. Herein, regions can include, but are not limited to, municipalities, cities, towns, counties, states, countries, or any other geographic or political grouping/entity.

Herein, a financial management system can be, but is not limited to, any data management system implemented on a computing system and/or accessed through a network that processes financial data, including payroll data, from one or more sources.

Herein, the term “financial management system” can denote, but is not limited to: computing system implemented, and/or online payroll management systems, packages, programs, modules, or applications; computing system implemented, and/or online, business financial management systems, packages, programs, modules, or applications; computing system implemented, and/or online, business tax preparation systems, packages, programs, modules, or applications; computing system implemented, and/or online, accounting and/or invoicing systems, packages, programs, modules, or applications; and various other electronic data management systems, packages, programs, modules, or applications, whether known at the time of filling or as developed later.

Several financial management systems are currently available to help companies automatically/semi-automatically create a payroll system and “run”, i.e., calculate, a payroll. However, each region, such as a city, county, state, country, or other political grouping, typically has its own regulations and requirements regarding the operation and running of a payroll. In addition, the rules and regulations regarding payroll, such as mandatory withholdings, tax rates, tax exempt, and non-tax exempt, income and programs, within a given region often change, with significant regularity and with significant effects on payroll operation and any given payroll run.

As noted above, this situation creates a longstanding problem for providers of financial management systems, such as payroll management systems, because it is almost impossible, and certainly impractical, to create a payroll “engine”, e.g., a payroll calculation module, that can take into account the rules and regulations for every region. In addition, even if a payroll engine were created to take into account even a fraction of the rules and regulations for multiple regions, when the rules and regulations for one of the regions change, which as noted above happens frequently within even a single region, the payroll engine created at such significant expense would then have to be re-created, or modified, and then re-distributed out to the users.

This represents a significant burden not only for the payroll system provider, but also for the users of the payroll system who would have to wait for the updated/latest version of the payroll system for their region and also constantly ensure they were indeed running the latest version. To try and address this problem, financial management system providers, e.g., payroll management system providers, often create multiple versions of their product with each version optimized for a defined region. However, this is, at best, a partial solution for at least two reasons.

First, it is not practical for the payroll system providers to make a dedicated version of their payroll management systems for each region. Consequently, for some regions a dedicated regional payroll management system is simply not available and must be essentially created on an individual basis, via local modification, by individual users in a region. However, even in regions where a payroll system optimized to that region is available, frequent rule and regulation changes within the region are still an issue. Consequently, the payroll system must still be frequently re-created, or modified, and then distributed out to the users. Again this represents a significant burden not only for the payroll system provider, but also for the users of the payroll system who would have to wait for the updated/latest version of the payroll system for their region and constantly ensure they are running the latest version.

To make matters worse, the number of companies that operate with locations in multiple regions is growing almost exponentially each year. Consequently, these potential users of payroll management systems have an ever increasing need for a payroll management system that is, or can be, optimized to multiple regions. However, as noted above, currently, payroll systems cannot provide this capability in an efficient, economical, or even practical way.

To address this issue, in one embodiment, payroll jurisdiction metadata for one or more regions is obtained and maintained separate from the financial management system, e.g., the payroll management system. Then company and employee data for a company and one or more employees associated with the company is also obtained and maintained separate from the financial management system, e.g., the payroll management system. In one embodiment, the payroll jurisdiction metadata for the region and the employee data for the company are provided to a payroll engine where the company and employee data for the company is transformed into regional payroll data for the company for the region using the payroll jurisdiction metadata for the region. In one embodiment, the regional payroll data for the company for the region is only then provided to the financial management system, e.g., the payroll management system.

Consequently, the process for providing a content based payroll compliance system discussed herein provides a payroll compliance system where the calculations and rules required for a given region, such as a given municipality, city, county, state, or country, at a given time, are described entirely within a set of jurisdiction metadata files for the region that are created and maintained independently from the financial management system, e.g., a payroll management application. This allows for the addition of new regions, as well as the updating and maintaining of existing regions, without having to recompile or redeploy a codebase, or a new version of the payroll application or module.

In one embodiment, payroll jurisdiction metadata for a region is obtained. In one embodiment, the payroll jurisdiction metadata for the region is provided by the provider of the process for providing a content based payroll compliance system. In one embodiment, the payroll jurisdiction metadata for the region is provided by an individual, e.g., a user of a financial management system, e.g., a payroll management system, and/or a user of the process for providing a content based payroll compliance system. In one embodiment, the payroll jurisdiction metadata for the region is provided by any individual or entity.

In one embodiment, the payroll jurisdiction metadata for a region includes a data, constants, and ordering file. In one embodiment, the data, constants, and ordering file includes one or more of tables data, constants data, form definition data, wage items data, and various other ordering data.

In one embodiment, the tables data of the data, constants, and ordering file of the payroll jurisdiction metadata for a region includes data representing tables used to perform various payroll calculations for a region and/or tax tables and lookup tables for the region.

As a specific illustrative example, various regions define tax tables for single employees differently from those with a spouse and children, i.e., those with allowed dependents. Typically, a tax table can be described using an upper and lower threshold and a set of values used to determine the amount of tax.

As an even more specific illustrative example, when the region is Australia, the payroll taxes are defined with a formula PayG=(A×X)+B and several different tables (named scales in this region) are used.

In one embodiment, the constants data of the data, constants, and ordering file of the payroll jurisdiction metadata for a region includes data representing constants that are values used within the payroll calculations that change relatively in-frequently, such as yearly. Providing the constants data in the data, constants, and ordering file of the payroll jurisdiction metadata for a region allows for making changes to these values without having to change calculation code.

For example, various regions define a percentage of gross pay that is used to determine the amount of retirement fund contribution that will be made. This is often called superannuation. In Australia this rate is 9%.

In one embodiment, a constant value represented in the constants data in the data, constants, and ordering file of the payroll jurisdiction metadata can be used within a calculation by referencing the constant by name.

In one embodiment, the form definition data of the data, constants, and ordering file of the payroll jurisdiction metadata for a region includes data representing forms that describe items that are required to be stored for compliance or calculation reasons by the region.

For example, when the region is Canada, each year an employee is required to fill out a TD-1 form (similar to a W2 in the US). This form describes the employees situation as it relates to their tax position.

In various regions, different forms and fields are used to determine the tax rates and deductions available. For instance, when Australia is the region, there are two forms required: The Tax File Number Declaration form and the Medicare Levy Variation Declaration form. Both of these forms must be stored for the employee and filed with the Australian Government.

In one embodiment, the wage items data of the data, constants, and ordering file of the payroll jurisdiction metadata for a region includes data representing wage items data that define the items on a pay check that are added to or subtracted from an employee's base pay. These include taxable and non-taxable deductions, hours worked, taxes withheld, and any other items that affect an employee's compensation.

In one embodiment, payroll calculation phases are defined that are common to virtually all regions. Then for each region each wage item is assigned a “phase” that defines the phase that it is associated with, e.g., that the wage item is run in, and an order that defines where in the phase the wage item belongs. In various embodiments, the payroll calculation phases include, but are not limited to income, pre-tax, tax, post-tax, and informational.

In one embodiment, wage items also declare the entry point within the calculation execution file, discussed below, where the payroll calculations for the wage items are defined.

In one embodiment, the payroll jurisdiction metadata for a region includes a calculation execution file including data assigning a function to each wage item of the data, constants, and ordering file of the payroll jurisdiction metadata.

In one embodiment, the functions are defined in JavaScript and the function name matches the assigned wage item. As an example, in one embodiment, the functions have the format:

Function[function name](parameters){ }

In one embodiment, parameters include, but are not limited to, basepay, e.g., the base salary for the employee; grosspay, e.g., the adjusted gross pay for the employee; and currentpay, e.g., the current net pay for the employee.

In one embodiment, the payroll jurisdiction metadata for the region, along with payroll jurisdiction metadata for other regions, is stored in a database and provided to a payroll calculation source. In one embodiment, the payroll calculation source is maintained separately from the financial management system, e.g., the payroll management system.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

In various embodiments, the process for providing a content based payroll compliance system is implemented as a Service Oriented Architecture (SOA) application. In these embodiments, the payroll calculation source is a payroll calculation service, or calculation service, within the SOA application implementing process for providing a content based payroll compliance system.

In one embodiment, the payroll calculation service implements a REpresentational State Transfer (REST) Application/Program Interface (API) where data is transferred as either Extensible Markup Language (XML) data or JavaScript Object Notation (JSON) data. In one embodiment, the payroll calculation service is stateless.

In one embodiment, company and employee data for a company and a region is obtained. In one embodiment, data is stored for companies and employees as a derivative of Tax Markup Language (TaxML), with each entity stored in XML with a Globally Unique Identifier (GUID) used as a key.

In one embodiment, company and employee data for a company and a region includes company data. As noted, in one embodiment, the company data is a derivative of Tax Markup Language (TaxML), with each entity stored in XML with a Globally Unique Identifier (GUID) used as a key.

In one embodiment, company and employee data for a company and a region includes employee data. In one embodiment, for each employee, employee data is created within a company and for a region that contains employee base data along with employee regional extension data specific to the region. Thus an extension mechanism is provided for each region for each employee.

In one embodiment, the employee base data stored for each employee contains personal information that is common across all regions such as, but not limited to, name, address, pay frequency, wage etc.

In one embodiment, the employee regional extension data defines data that is required to maintain compliance, or that is required to create valid calculations, within the region and potentially varies from region to region, such as the forms data discussed above.

In one embodiment, the company and employee data for a company and a region is stored in a database and provided to a company and employee data source. In one embodiment, the company and employee data source is maintained separately from the financial management system, e.g., the payroll management system.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

In various embodiments, the process for providing a content based payroll compliance system is implemented as a Service Oriented Architecture (SOA) application. In these embodiments, the company and employee data source is a company and employee data service, or data service, within the SOA application implementing process for providing a content based payroll compliance system.

In one embodiment, the company and employee data service implements a REpresentational State Transfer (REST) Application/Program Interface (API) where data is transferred as either Extensible Markup Language (XML) data or JavaScript Object Notation (JSON) data. In one embodiment, the company and employee data service is stateless.

In one embodiment, a payroll engine is provided for calculating, or running a payroll, and generating regionally optimized payroll data.

In one embodiment, the payroll engine is a content system that allows for the uploading and updating of the payroll jurisdiction metadata while the financial management system application is running, e.g., while the payroll management system is installed and running. Consequently, a user in a region not currently supported can create the required payroll jurisdiction metadata files and upload them and then have a payroll management system optimized for their region; not only for their use, but also for the use of anyone else in that region. Consequently a provider of a financial management system using the process for providing a content based payroll compliance system is provided the ability to focus and create the regionally optimized files without having to redeploy an application to gain support for a desired region.

As noted above, in one embodiment, the process for providing a content based payroll compliance system is implemented as a Service Oriented Architecture (SOA) application. In these embodiments, the payroll engine includes SOA related functions and modules such as, but not limited to, a caching service and an orchestration module/function, such as an orchestration module/function provided by Mulesoft™.

In one embodiment, the payroll engine is provided access to the payroll jurisdiction metadata for the region and the company and employee data for the company and one or more employees associated with the company for the region.

In one embodiment, the payroll engine then transforms the company and employee data for the region into regional payroll data using the payroll jurisdiction metadata for the region.

In one embodiment, the payroll engine transforms the company and employee data for the region into regional payroll data using the payroll jurisdiction metadata for the region by linking a company and employee to the corresponding region definition. The regional payroll data is generated, i.e., the regionally optimized payroll is run, for the company using the following basic approach:

1. Iterate through each employee;

2. Calculate the base pay;

3. Create an execution context;

4. Store each jurisdiction form within the context;

5. Store tables within the context;

6. Store constants within the context;

7. Iterate through the income phase wage items and call the calculation function with the execution context;

8. For each wage item, update the gross pay and current pay by adding the result of the calculation and add the result to the current paystub;

9. Iterate through the pre-tax phase wage items and call the calculation function with the execution context;

10. For each wage item, update the current pay by subtracting the result of the calculation and adding the result to the current paystub;

11. Iterate through the tax wage items and call the calculation function with the execution context.

12. For each wage item, add to the total tax amount and add the result to the current paystub.

13. Set the current pay to the gross pay from 7. less the total tax amount from 11;

14. Iterate through the post-tax wage items and call the calculation function with the execution context;

15. For each wage item, update the current pay by subtracting the result of the calculation and adding the result to the current paystub. The current pay at the end of this step is the final amount for the paycheck.

16. Iterate through the information wage items and call the calculation function with the execution context.

17. For each wage item, add the result to the current paystub.

In one embodiment, the regional payroll data is provided to the financial management system, e.g., the payroll management system.

Using the system and method for providing a content based payroll compliance system discussed herein, payroll jurisdiction metadata for one or more regions is obtained and maintained separate from the financial management system, e.g., the payroll management system. Then company and employee data for a company and one or more employees associated with the company is also obtained and maintained separate from the financial management system, e.g., the payroll management system. In one embodiment, the payroll jurisdiction metadata for the region and the employee data for the company are provided to a payroll engine where the company and employee data for the company is transformed into regional payroll data for the company for the region using the payroll jurisdiction metadata for the region. In one embodiment, the regional payroll data for the company for the region is only then provided to the financial management system, e.g., the payroll management system.

Consequently, using the method and system for providing a content based payroll compliance system discussed herein a payroll compliance system is provided where the calculations and rules required for a given region, such as a given municipality, city, county, state, or country, at a given time, are described entirely within a set of jurisdiction metadata files for the region that are created and maintained independently from the financial management system, e.g., a payroll management application. This allows for the addition of new regions, as well as the updating and maintaining of existing regions, without having to recompile or redeploy a codebase, or a new version of the payroll application or module.

### Hardware System Architecture

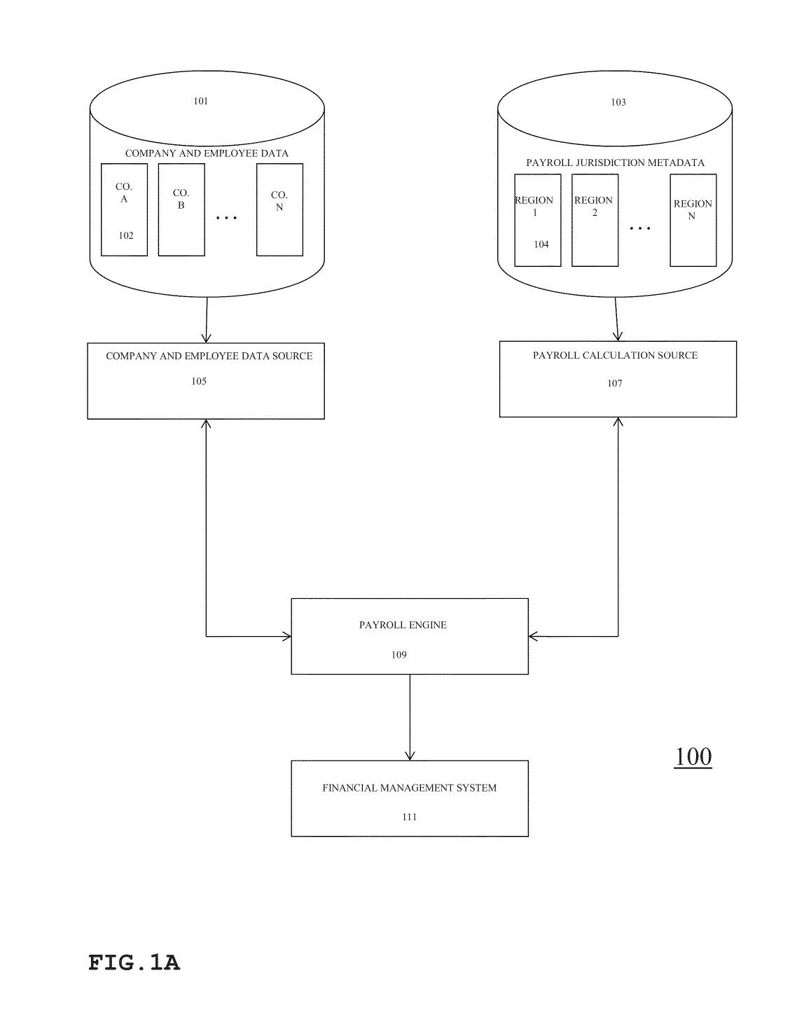

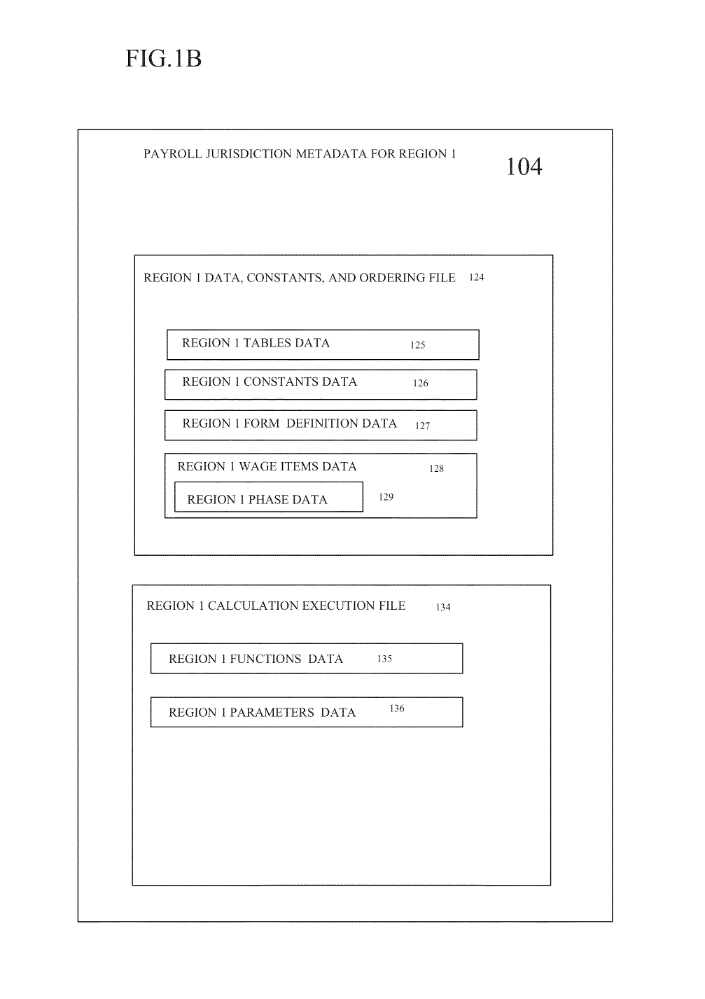

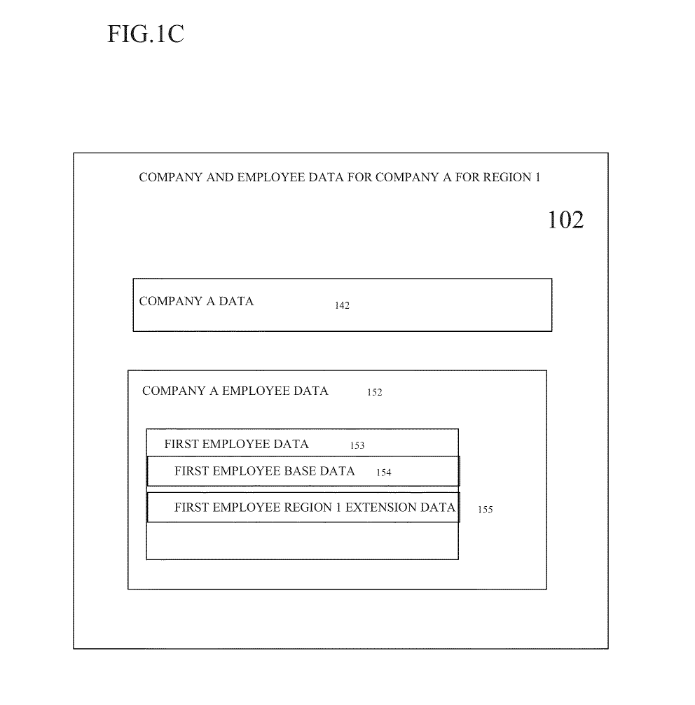

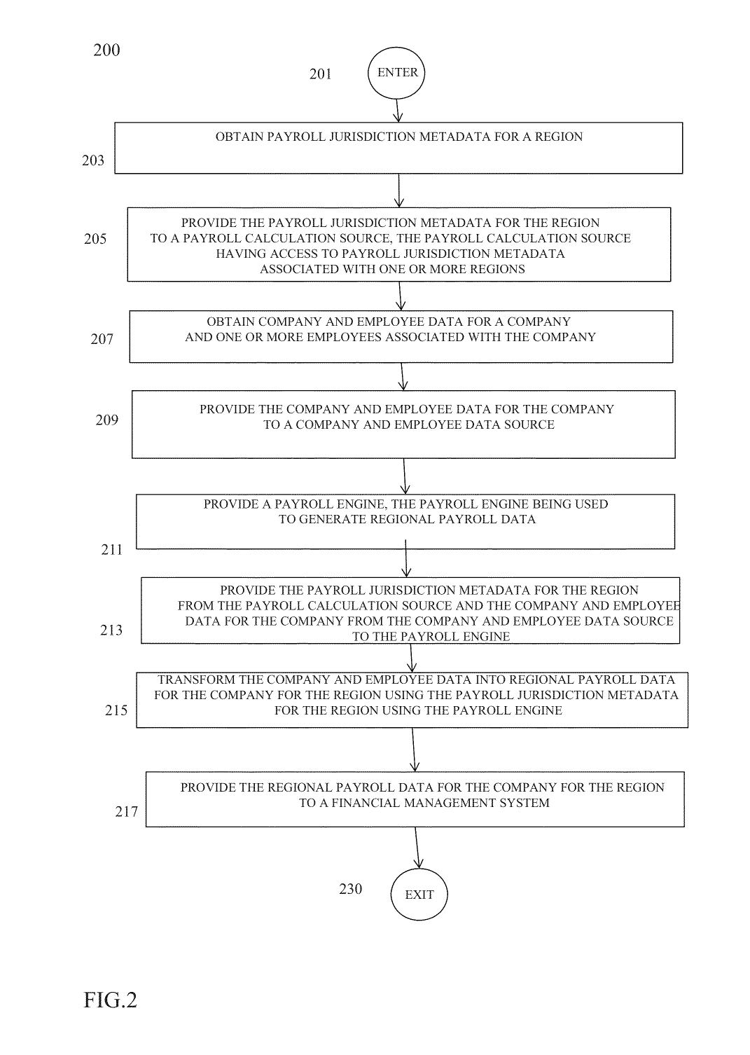

FIG. 1A is a block diagram of an exemplary architecture for implementing one embodiment of a process for providing a content based payroll compliance system, such as exemplary process 200 (FIG. 2) discussed herein.

Shown in FIG. 1A are a company and employee database 101 including company and employee data for “N” companies, i.e., company and employee data for companies A thru N shown as company A (CO.A 102), company B (CO.B), thru company N (CO.N); a payroll jurisdictional database 103 including payroll jurisdictional data for “N” regions, i.e., payroll jurisdictional data for a first region thru an “Nth” region, shown as region 1 (104), region 2, thru region N; company and employee data source 105; payroll calculation source 107; payroll engine 109; and financial management system 111.

The process for providing a content based payroll compliance system discussed herein provides a payroll compliance system where the calculations and rules required for a given region, such as a given municipality, city, county, state, or country, at a given time, are described entirely within a set of jurisdiction metadata files for the region, e.g., jurisdiction metadata files for region 1 (104), that are created and maintained independently from the financial management system, e.g., a payroll management application, such as financial management system 111. This allows for the addition of new regions, such as region 2 thru region N, as well as the updating and maintaining of existing regions, without having to recompile or redeploy a codebase, or a new version financial management system 111.

In one embodiment, payroll jurisdiction metadata for a region, e.g., region 1 (104) in FIG. 1A, is obtained. In one embodiment, the payroll jurisdiction metadata for the region, e.g., region 1 (104) in FIG. 1A, is provided by the provider of the process for providing a content based payroll compliance system. In one embodiment, the payroll jurisdiction metadata for the region e.g., region 1 (104) in FIG. 1A, is provided by an individual, e.g., a user of financial management system 111, e.g., a payroll management system, and/or a user of the process for providing a content based payroll compliance system. In one embodiment, the payroll jurisdiction metadata for the region is provided by any individual or entity.

In one embodiment, the payroll jurisdiction metadata for a region e.g., region 1 (104) in FIG. 1A, includes a data, constants, and ordering file. In one embodiment, the data, constants, and ordering file includes one or more of tables data, constants data, form definition data, wage items data, and various other ordering data.

FIG. 1B shows the format of the payroll jurisdiction metadata for region 1 (104) of FIG. 1A, including region 1 data, constants, and ordering file 124 and region 1 calculation and execution file 134.

In one embodiment, the region 1 tables data 125 of region 1 data, constants, and ordering file 124 of the payroll jurisdiction metadata for region 1(104) includes data representing tables used to perform various payroll calculations for region 1 and/or tax tables and lookup tables for region 1.

As a specific illustrative example, various regions define tax tables for single employees differently from those with a spouse and children, i.e., those with allowed dependents. Typically, a tax table can be described using an upper and lower threshold and a set of values used to determine the amount of tax.

In one embodiment, the region 1 constants data 126 of the region 1 data, constants, and ordering file 124 of the payroll jurisdiction metadata for region 1(104) includes data representing constants that are values used within the payroll calculations that change relatively in-frequently, such as yearly. Providing the constants data in the data, constants, and ordering file of the payroll jurisdiction metadata for a region allows for making changes to these values without having to change calculation code.

In one embodiment, the form definition data 127 of the region 1 data, constants, and ordering file of the payroll jurisdiction metadata for region 1(104) includes data representing forms that describe items that are required to be stored for compliance or calculation reasons by region 1.

In one embodiment, the wage items data 128 of the region 1 data, constants, and ordering file of the payroll jurisdiction metadata for region 1 (104) includes data representing wage items data that define the items on a pay check that are added to, or subtracted from, an employee's base pay. These include taxable and non-taxable deductions, hours worked, taxes withheld, and any other items that affect an employee's compensation.

In one embodiment, region 1 phase data 129 includes data indicating payroll calculation phases that are common to virtually all regions. Then for each region each wage item is assigned a “phase” that defines the phase that it is associated with, e.g., that the wage item is run in, and an order that defines where in the phase the wage item belongs. In various embodiments, the payroll calculation phases include, but are not limited to income, pre-tax, tax, post-tax, and informational.

In one embodiment, wage items also declare the entry point within the calculation execution file, discussed below, where the payroll calculations for the wage items are defined.

In one embodiment, the payroll jurisdiction metadata for region 1 (104) includes a region 1 calculation execution file 134 including region 1 functions data 135 assigning a function to each wage item of the region 1 data, constants, and ordering file 124 of the payroll jurisdiction metadata for region 1 (104).

In one embodiment, the functions are defined in JavaScript and the function name matches the assigned wage item.

In one embodiment, region 1 parameters data 136 includes data defining parameters that include, but are not limited to, basepay, e.g., the base salary for the employee; grosspay, e.g., the adjusted gross pay for the employee; and currentpay, e.g., the current net pay for the employee.

Returning to FIG. 1A, in one embodiment, the payroll jurisdiction metadata for region 1 (104), along with payroll jurisdiction metadata for other regions, is stored in a database, such as database 103 and provided to a payroll calculation source 107. In one embodiment, payroll calculation source 107 is maintained separately from financial management system 111, e.g., the payroll management system.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

In various embodiments, the process for providing a content based payroll compliance system is implemented as a Service Oriented Architecture (SOA) application. In these embodiments, payroll calculation source 107 is a payroll calculation service, or calculation service, within the SOA application implementing process for providing a content based payroll compliance system.

In one embodiment, the payroll calculation service implements a REpresentational State Transfer (REST) Application/Program Interface (API) where data is transferred as either Extensible Markup Language (XML) data or JavaScript Object Notation (JSON) data. In one embodiment, the payroll calculation service is stateless.

FIG. 1C shows the format of company and employee data for company A for region 1 (102), i.e., CO.A 102 of FIG. 1A. In one embodiment, company and employee data for company A for region 1 (102) is stored as a derivative of Tax Markup Language (TaxML), with each entity stored in XML with a Globally Unique Identifier (GUID) used as a key.

In one embodiment, company and employee data for company A for region 1 (102) includes company A data 142. As noted, in one embodiment, company A data 142 is a derivative of Tax Markup Language (TaxML), with each entity stored in XML with a Globally Unique Identifier (GUID) used as a key.

In one embodiment, company and employee data for company A for region 1 (102) includes company A employee data 152. In one embodiment, for each employee, employee data is created within a company and for a region that contains employee base data along with employee regional extension data specific to the region. Thus an extension mechanism is provided for each region for each employee.

In one embodiment, the employee base data stored for each employee contains personal information that is common across all regions such as, but not limited to, name, address, pay frequency, wage etc.

In one embodiment, the employee regional extension data defines data that is required to maintain compliance, or that is required to create valid calculations, within the region and potentially varies from region to region, such as the forms data discussed above.

As seen in FIG. 1C, company A employee data 152 includes first employee data 153 with first employee base data 154 and first employee region 1 extension data 155.

Returning to FIG. 1A, in one embodiment, company and employee data for company A for region 1 (102) is stored in a database, such as database 101 of FIG. 1A, and provided to company and employee data source 105. In one embodiment, company and employee data source 105 is maintained separately from financial management system 111, e.g., the payroll management system.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

In various embodiments, process for providing a content based payroll compliance system is implemented as a Service Oriented Architecture (SOA) application. In these embodiments, company and employee data source 105 is a company and employee data service, or data service, within the SOA application implementing process for providing a content based payroll compliance system.

In one embodiment, the company and employee data service implements a REpresentational State Transfer (REST) Application/Program Interface (API) where data is transferred as either Extensible Markup Language (XML) data or JavaScript Object Notation (JSON) data. In one embodiment, the company and employee data service is stateless.

In one embodiment, payroll engine 109 is provided for calculating, or running a payroll, and generating regionally optimized payroll data.

In one embodiment, payroll engine 109 is a content system that allows for the uploading and updating of payroll jurisdiction metadata while financial management system 111 is running, e.g., while the payroll management system is installed and running. Consequently, a user in a region not currently supported can create the required payroll jurisdiction metadata files and upload them and then have a payroll management system optimized for their region; not only for their use, but also for the use of anyone else in that region. Consequently a provider of financial management system 111 using the process for providing a content based payroll compliance system is provided the ability to focus and create the regionally optimized files without having to redeploy an application to gain support for a desired region.

As noted above, in one embodiment, the process for providing a content based payroll compliance system is implemented as a Service Oriented Architecture (SOA) application. In these embodiments, payroll engine 109 includes SOA related functions and modules such as, but not limited to, a caching service and an orchestration module/function, such as an orchestration module/function provided by Mulesoft™.

As discussed below, in one embodiment, payroll engine 109 transforms the company and employee data for the region into regional payroll data using the payroll jurisdiction metadata for the region.

In the discussion above, certain aspects of one embodiment include processes, sub-processes, steps, operations and/or instructions described herein for illustrative purposes in a particular order and/or grouping. However, the particular order and/or grouping shown and discussed herein are illustrative only and not limiting. Those of skill in the art will recognize that other orders and/or grouping of the processes, sub-processes, steps, operations and/or instructions are possible and, in some embodiments, one or more of the processes, sub-processes, steps, operations and/or instructions discussed above can be combined and/or deleted. In addition, portions of one or more of the processes, sub-processes, steps, operations and/or instructions can be re-grouped as portions of one or more other of processes, sub-processes, steps, operations and/or instructions discussed herein. Consequently, the particular order and/or grouping of the processes, sub-processes, steps, operations and/or instructions discussed herein do not limit the scope of the invention as claimed below.

### Process

In accordance with one embodiment, a system and method for providing a content based payroll compliance system includes a process for providing a content based payroll compliance system implemented by one or more processors associated with one or more computing systems.

As used herein, the term “computing system”, includes, but is not limited to, a desktop computing system; a portable computing system; a mobile computing system; a laptop computing system; a notebook computing system; a tablet computing system; a workstation; a server computing system; a mobile phone; a smart phone; a wireless telephone; a two-way pager; a Personal Digital Assistant (PDA); a media player, i.e., an MP3 player and/or other music and/or video player; an Internet appliance; or any device that includes components that can execute all, or part, of any one of the processes and/or operations as described herein.

In addition, as used herein, the term computing system, can denote, but is not limited to, systems made up of multiple desktop computing systems; portable computing systems; mobile computing systems; laptop computing systems; notebook computing systems; tablet computing systems; workstations; server computing systems; smart phones; wireless telephones; two-way pagers; Personal Digital Assistants (PDAs); media players; Internet appliances; or any devices that can be used to perform the processes and/or operations as described herein.

In one embodiment, one or more computing systems are connected by one or more communications channels, such as, but not limited to: any general network, communications network, or general network/communications network system; a cellular network; a wireless network; a combination of different network types; a public network; a private network; a satellite network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

In accordance with one embodiment, the process for providing a content based payroll compliance system is part of, linked to, or otherwise associated with, one or more financial management systems used by one or more of the one or more individuals.

Herein the terms “individual” and “user” are used interchangeably and include, but are not limited to, any individual party and/or entity as discussed herein, and/or as defined in the art at the time of filing, and/or as defined after the time of filing.

Herein, a financial management system can be, but is not limited to, any data management system implemented on a computing system and/or accessed through a network that processes financial data, including payroll data, from one or more sources.

Herein, the term “financial management system” can denote, but is not limited to: computing system implemented, and/or online payroll management systems, packages, programs, modules, or applications; computing system implemented, and/or online, business financial management systems, packages, programs, modules, or applications; computing system implemented, and/or online, business tax preparation systems, packages, programs, modules, or applications; computing system implemented, and/or online, accounting and/or invoicing systems, packages, programs, modules, or applications; and various other electronic data management systems, packages, programs, modules, or applications, whether known at the time of filling or as developed later.

Several financial management systems are currently available to help companies automatically/semi-automatically create a payroll system and “run”, i.e., calculate, a payroll. However, each region, such as a city, county, state, country, or other political grouping, typically has its own regulations and requirements regarding the operation and running of a payroll. In addition, the rules and regulations regarding payroll, such as mandatory withholdings, tax rates, tax exempt, and non-tax exempt, income and programs, within a given region often change, with significant regularity and with significant effects on payroll operation and any given payroll run.

As noted above, this situation creates a longstanding problem for providers of financial management systems, such as payroll management systems, because it is almost impossible, and certainly impractical, to create a payroll “engine”, e.g., a payroll calculation module, that can take into account the rules and regulations for every region. In addition, even if a payroll engine were created to take into account even a fraction of the rules and regulations for multiple regions, when the rules and regulations for one of the regions change, which as noted above happens frequently within even a single region, the payroll engine created at such significant expense would then have to be re-created, or modified, and then re-distributed out to the users.

This represents a significant burden not only for the payroll system provider, but also for the users of the payroll system who would have to wait for the updated/latest version of the payroll system for their region and also constantly ensure they were indeed running the latest version. To try and address this problem, financial management system providers, e.g., payroll management system providers, often create multiple versions of their product with each version optimized for a defined region. However, this is, at best, a partial solution for at least two reasons.

First, it is not practical for the payroll system providers to make a dedicated version of their payroll management systems for each region. Consequently, for some regions a dedicated regional payroll management system is simply not available and must be essential created on an individual basis, via local modification, by individual users in a region. However, even in regions where a payroll system optimized to that region is available, frequent rule and regulation changes within the region are still an issue. Consequently, the payroll system must still be frequently re-created, or modified, and then distributed out to the users. Again this represents a significant burden not only for the payroll system provider, but also for the users of the payroll system who have to wait for the updated/latest version of the payroll system for their region and constantly ensure they are running the latest version.

To make matters worse, the number of companies that operate with locations in multiple regions is growing almost exponentially each year. Consequently, these potential users of payroll management systems have an ever increasing need for a payroll management system that is, or can be, optimized to multiple regions. However, as noted above, currently, payroll systems cannot provide this capability in an efficient, economical, or even practical way.

To address this issue, in accordance with one embodiment, a process for providing a content based payroll compliance system includes obtaining payroll jurisdiction metadata for a region and providing the payroll jurisdiction metadata for the region to a payroll calculation source, the payroll calculation source having access to payroll jurisdiction metadata associated with one or more regions. In one embodiment, company and employee data for a company and one or more employees associated with the company is then obtained and provided to a company and employee data source. In one embodiment, the payroll jurisdiction metadata for the region from the payroll calculation source and the company and employee data for the company from the company and employee data source is provided to a payroll engine where the company and employee data for the company is transformed into regional payroll data for the company for the region using the payroll jurisdiction metadata for the region. In one embodiment, the regional payroll data for the company for the region is provided to a financial management system.

Consequently, the process for providing a content based payroll compliance system provides a payroll compliance system where the calculations and rules required for a given region, such as a given municipality, city, county, state, or country are described entirely within a set of jurisdiction metadata files for a region that are created and maintained independently from the financial management system, e.g., a payroll application. This allows for the addition of new regions, as well as the updating and maintaining of existing regions, without having to recompile or redeploy a codebase, or a new version of the payroll application or module.

FIG. 2 is a flow chart depicting a process 200 for providing a content based payroll compliance system in accordance with one embodiment. Process 200 for providing a content based payroll compliance system begins at ENTER OPERATION 201 of FIG. 2 and process flow proceeds to OBTAIN PAYROLL JURISDICTION METADATA FOR A REGION OPERATION 203.

In one embodiment, at OBTAIN PAYROLL JURISDICTION METADATA FOR A REGION OPERATION 203 payroll jurisdiction metadata for a region is obtained.

Herein the term “region” includes any entity or place that has the power to dictate rules, regulations, taxes, or other criteria that have an effect on payroll calculations, or must be taken into consideration when running a payroll. Herein, regions can include, but are not limited to, municipalities, cities, towns, counties, states, countries, or any other geographic or political grouping/entity.

In one embodiment, the payroll jurisdiction metadata for the region of OBTAIN PAYROLL JURISDICTION METADATA FOR A REGION OPERATION 203 is provided by the provider of process 200 for providing a content based payroll compliance system.

In one embodiment, the payroll jurisdiction metadata for the region is provided by an individual, e.g., a user of a financial management system, e.g., a payroll management system, and/or a user of process 200 for providing a content based payroll compliance system. In one embodiment, the payroll jurisdiction metadata for the region is provided by any individual or entity.

In one embodiment, the payroll jurisdiction metadata for a region of OBTAIN PAYROLL JURISDICTION METADATA FOR A REGION OPERATION 203 is specific to, or optimized for, the region and includes a data, constants, and ordering file.

In one embodiment, the data, constants, and ordering file includes one or more of tables data, constants data, form definition data, wage items data, and various other ordering data.

In one embodiment, the tables data of the data, constants, and ordering file of the payroll jurisdiction metadata for a region of OBTAIN PAYROLL JURISDICTION METADATA FOR A REGION OPERATION 203 includes data representing tables used to perform various payroll calculations for the region and/or tax tables and lookup tables for the region.

As a specific illustrative example, various regions define tax tables for single employees differently from those with a spouse and children, i.e., those with allowed dependents. Typically, a tax table can be described using an upper and lower threshold and a set of values used to determine the amount of tax.

As an even more specific illustrative example, when the region is Australia, the payroll taxes are defined with a formula PayG=(A×X)+B and several different tables (named scales in this region) are used.

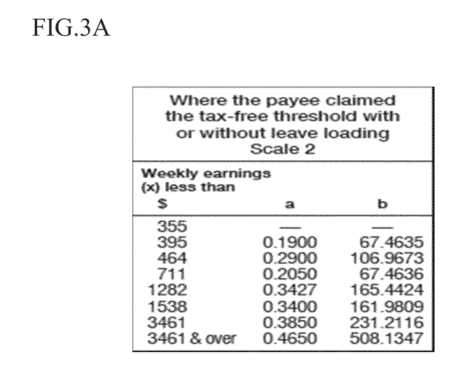

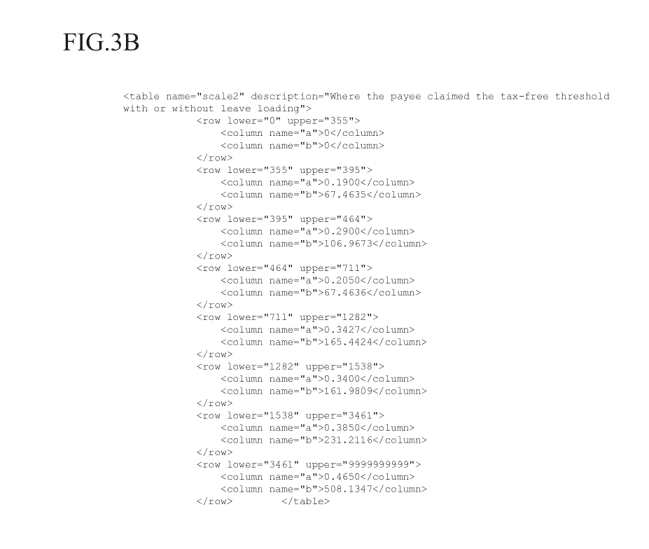

FIG. 3A shows an exemplary tax table and FIG. 3B shows the codification of the tax table of FIG. 3A in accordance with one specific illustrative example of one embodiment.

In one embodiment, the code of FIG. 3B can then be used by the calculation execution files, discussed below, to obtain the correct and relevant tax values for the region.

In one embodiment, the constants data of the data, constants, and ordering file of the payroll jurisdiction metadata for a region of OBTAIN PAYROLL JURISDICTION METADATA FOR A REGION OPERATION 203 includes data representing constants that are values used within the payroll calculations that change relatively in-frequently, such as yearly.

Providing the constants data in the data, constants, and ordering file of the payroll jurisdiction metadata for a region of OBTAIN PAYROLL JURISDICTION METADATA FOR A REGION OPERATION 203 allows for making changes to these values without having to change the calculation code of the calculation execution files, discussed below.

For example, various regions define a percentage of gross pay that is used to determine the amount of retirement fund contribution that will be made. This is often called superannuation. In Australia this rate is 9%.

In one embodiment, a constant value represented in the constants data in the data, constants, and ordering file of the payroll jurisdiction metadata can be used within a calculation performed by the calculation execution files, discussed below, by referencing the constant by name.

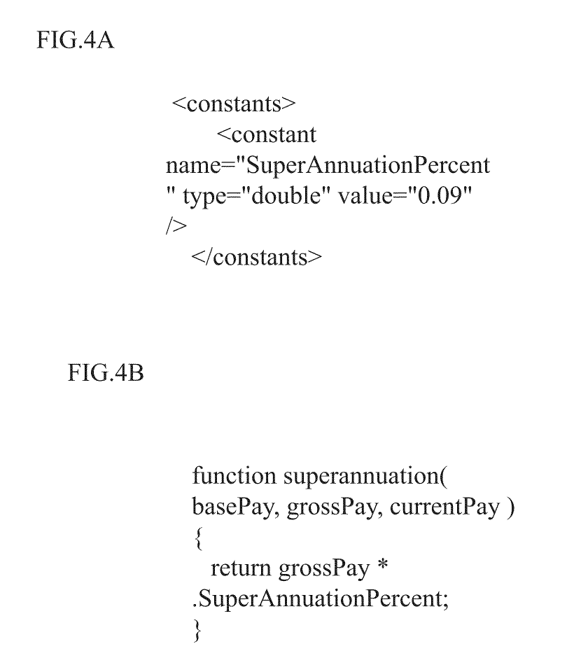

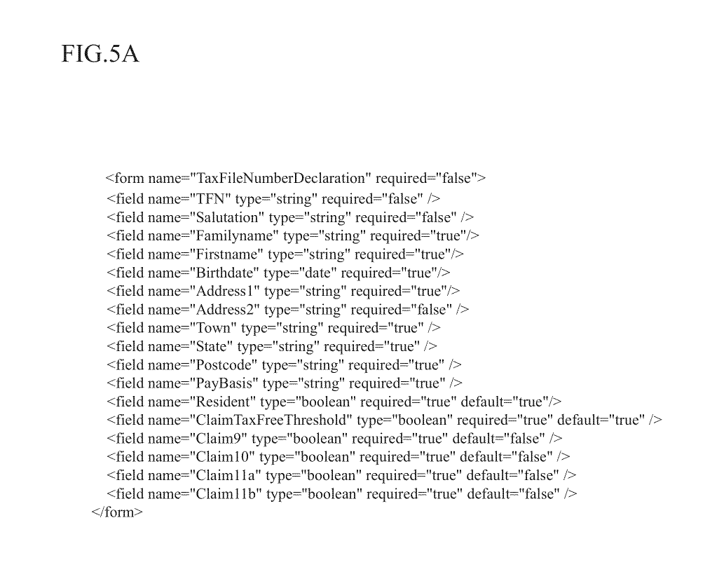

FIG. 4A shows the code format of a constant for superannuation in the region of Australia where this rate is 9% in accordance with one illustrative example. FIG. 4B shows the codified constant of FIG. 4A referenced by name in a calculation function performed by the calculation execution files, discussed below, in accordance with one illustrative example.

In one embodiment, the form definition data of the data, constants, and ordering file of the payroll jurisdiction metadata for a region of OBTAIN PAYROLL JURISDICTION METADATA FOR A REGION OPERATION 203 includes data representing forms that describe items that are required to be stored for compliance or calculation reasons by the region.

For example, when the region is Canada, each year an employee is required to fill out a TD-1 form (similar to a W2 in the US). This form describes the employees situation as it relates to their tax position.

In various regions, different forms and fields are used to determine the tax rates and deductions available. For instance, when Australia is the region, there are two forms required: The Tax File Number Declaration form and the Medicare Levy Variation Declaration form. Both of these forms must be stored for the employee and filed with the Australian Government.

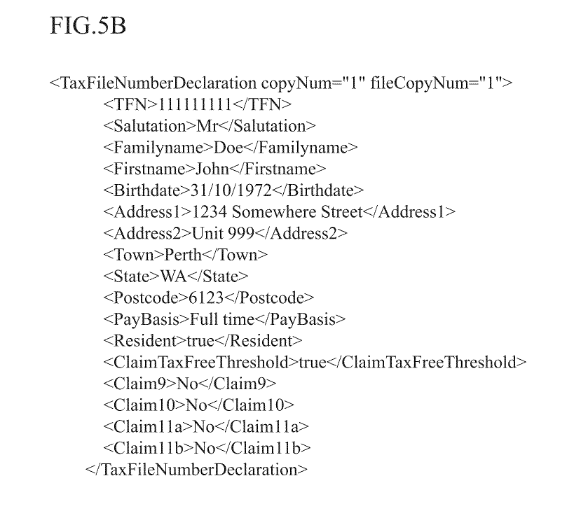

FIG. 5A shows what the codified Tax File Number Declaration would look like in an illustrative example. Referring to FIG. 5A, within this definition of FIG. 5A is an entry for each field along with a definition of that field (type, required and defaults). In one embodiment, when this data is entered it is stored with the employee data. FIG. 5B shows what the codified form of FIG. 5A looks like for a fictional user with data. In this specific illustrative example, each field within the data is accessible within the calculations using the form name and field. For example: TaxFileNumberDeclaration.Resident.

In one embodiment, the wage items data of the data, constants, and ordering file of the payroll jurisdiction metadata of OBTAIN PAYROLL JURISDICTION METADATA FOR A REGION OPERATION 203 for a region includes data representing wage items data that define the items on a pay check that are added to, or subtracted from, an employee's base pay. These include taxable and non-taxable deductions, hours worked, taxes withheld, and any other items that affect an employee's compensation.

In one embodiment, payroll calculation phases are defined that are common to virtually all regions. Then for each region each wage item is assigned a “phase” that defines the processing step that it is associated with, e.g., that the wage item is run in, and an order that defines where in the phase the wage item belongs. In various embodiments, the payroll calculation phases include, but are not limited to income, pre-tax, tax, post-tax, and informational.

In one embodiment, wage items also declare the entry point within the calculation execution file, discussed below, where the payroll calculations for the wage items are defined.

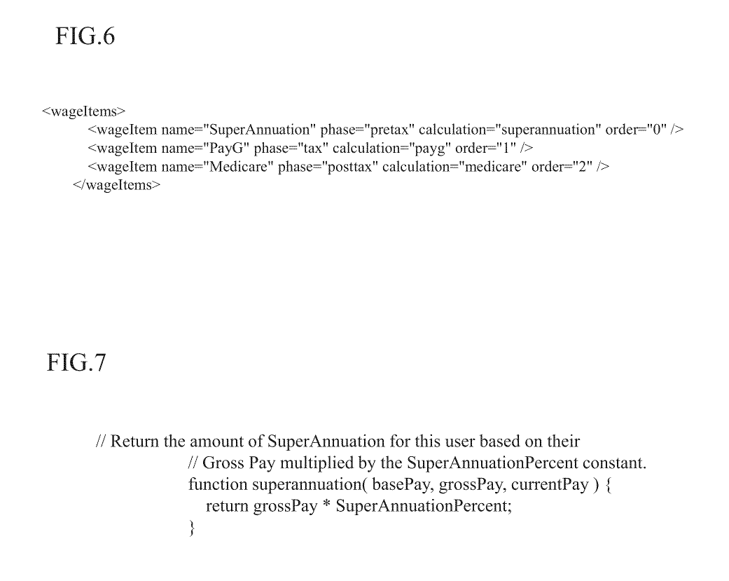

FIG. 6 shows an illustrative example of a codified wage item, “superannuation”, with the phase “pretax” in accordance with one embodiment.

In one embodiment, the payroll jurisdiction metadata for a region of OBTAIN PAYROLL JURISDICTION METADATA FOR A REGION OPERATION 203 includes a calculation execution file including data assigning a function to each wage item of the data, constants, and ordering file of the payroll jurisdiction metadata.

In one embodiment, the functions are defined in JavaScript and the function name matches the assigned wage item. As an example, in one embodiment, the functions have the format: Function[function name](parameters){ }.

In one embodiment, parameters include, but are not limited to, basepay, e.g., the base salary for the employee; grosspay, e.g., the adjusted gross pay for the employee; and currentpay, e.g., the current net pay for the employee.

FIG. 7 shows the codification of the function “superannuation” with the parameter “gross pay” in accordance with one illustrative example of one embodiment.

In one embodiment, once the financial management system payroll jurisdiction metadata for a region is obtained at OBTAIN PAYROLL JURISDICTION METADATA FOR A REGION OPERATION 203, process flow proceeds to PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205.

In one embodiment, at PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205, the payroll jurisdiction metadata for the region of OBTAIN PAYROLL JURISDICTION METADATA FOR A REGION OPERATION 203, along with payroll jurisdiction metadata for other regions, is uploaded and stored in a database. A payroll calculation source is provided access to the database and the payroll jurisdiction metadata.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

In one embodiment, at PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205 the payroll calculation source is maintained separately from the financial management system, e.g., the payroll management system.

In various embodiments, process 200 for providing a content based payroll compliance system is implemented as a Service Oriented Architecture (SOA) application. In these embodiments, the payroll calculation source of PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205 is a payroll calculation service, or calculation service, within the SOA application implementing process 200 for providing a content based payroll compliance system.

In one embodiment, the payroll calculation service of PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205 implements a REpresentational State Transfer (REST) Application/Program Interface (API) where data is transferred as either Extensible Markup Language (XML) data or JavaScript Object Notation (JSON) data.

In one embodiment, the payroll calculation service of PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205 is stateless.

In one embodiment, once the payroll jurisdiction metadata for the region of OBTAIN PAYROLL JURISDICTION METADATA FOR A REGION OPERATION 203, along with payroll jurisdiction metadata for other regions, is uploaded and stored in a database and the payroll calculation source is provided access to the database and the payroll jurisdiction metadata at PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205, process flow proceeds to OBTAIN COMPANY AND EMPLOYEE DATA FOR A COMPANY AND ONE OR MORE EMPLOYEES ASSOCIATED WITH THE COMPANY OPERATION 207.

In one embodiment, at OBTAIN COMPANY AND EMPLOYEE DATA FOR A COMPANY AND ONE OR MORE EMPLOYEES ASSOCIATED WITH THE COMPANY OPERATION 207, company and employee data for a company and a region is obtained.

In one embodiment, the company and employee data for a company and a region obtained at OBTAIN COMPANY AND EMPLOYEE DATA FOR A COMPANY AND ONE OR MORE EMPLOYEES ASSOCIATED WITH THE COMPANY OPERATION 207 includes data stored for companies and employees as a derivative of Tax Markup Language (TaxML), with each entity stored in XML with a Globally Unique Identifier (GUID) used as a key.

In one embodiment, company and employee data for a company and a region of OBTAIN COMPANY AND EMPLOYEE DATA FOR A COMPANY AND ONE OR MORE EMPLOYEES ASSOCIATED WITH THE COMPANY OPERATION 207, includes company data. As noted, in one embodiment, the company data is a derivative of Tax Markup Language (TaxML), with each entity stored in XML with a Globally Unique Identifier (GUID) used as a key.

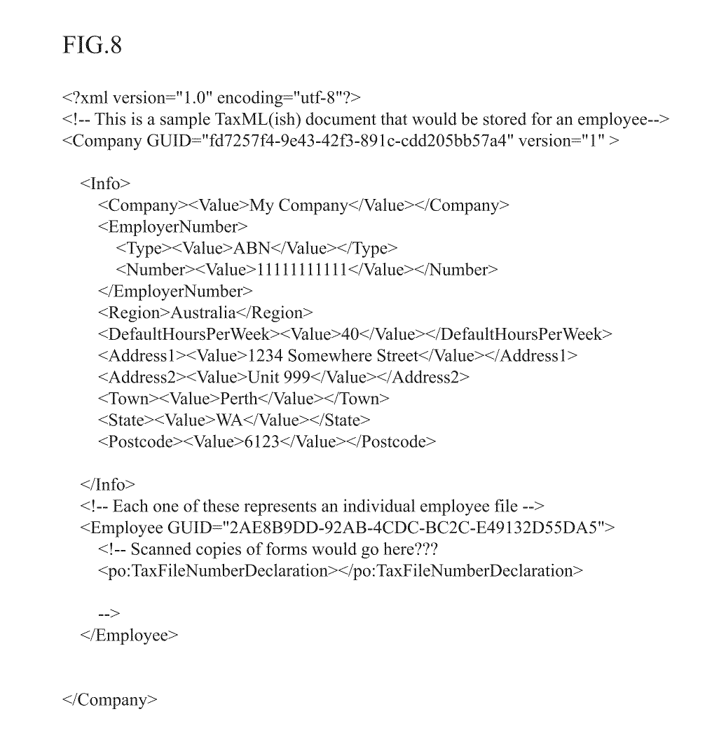

FIG. 8 shows company data codified in accordance with one specific illustrative example of one embodiment.

In one embodiment, the company and employee data for a company and a region of OBTAIN COMPANY AND EMPLOYEE DATA FOR A COMPANY AND ONE OR MORE EMPLOYEES ASSOCIATED WITH THE COMPANY OPERATION 207, includes employee data.

In one embodiment, for each employee, employee data is created within the company and for a region that contains employee base data along with employee regional extension data specific to the region. Thus an extension mechanism is provided for each region for each employee.

In one embodiment, the employee base data stored for each employee contains personal information that is common across all regions such as, but not limited to, name, address, pay frequency, wage etc.

In one embodiment, the employee regional extension data defines data that is required to maintain compliance, or that is required to create valid calculations, within the region and potentially varies from region to region, such as the forms data discussed above.

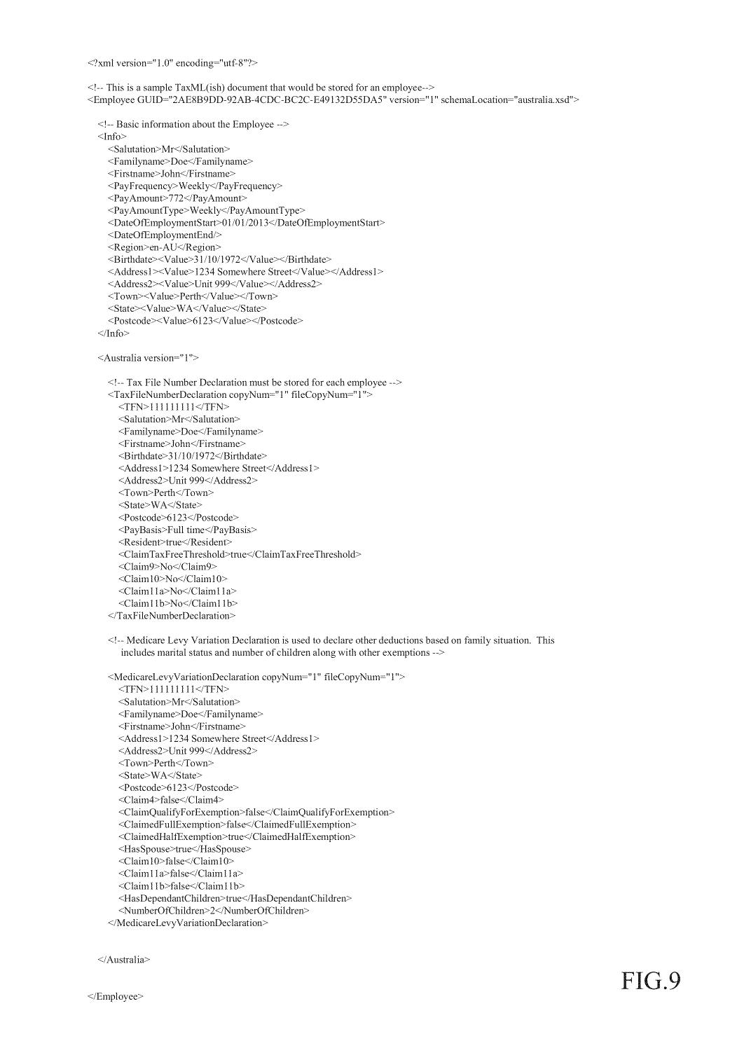

FIG. 9 shows codified employee data in accordance with one illustrative example of one embodiment.

In one embodiment, once company and employee data for a company and a region is obtained at OBTAIN COMPANY AND EMPLOYEE DATA FOR A COMPANY AND ONE OR MORE EMPLOYEES ASSOCIATED WITH THE COMPANY OPERATION 207, process flow proceeds to PROVIDE THE COMPANY AND EMPLOYEE DATA FOR THE COMPANY TO A COMPANY AND EMPLOYEE DATA SOURCE OPERATION 209.

In one embodiment, at PROVIDE THE COMPANY AND EMPLOYEE DATA FOR THE COMPANY TO A COMPANY AND EMPLOYEE DATA SOURCE OPERATION 209 the company and employee data for a company and a region of OBTAIN COMPANY AND EMPLOYEE DATA FOR A COMPANY AND ONE OR MORE EMPLOYEES ASSOCIATED WITH THE COMPANY OPERATION 207 is stored in a database and a company and employee data source is provided access to the database and the company and employee data.

In one embodiment, the company and employee data source of PROVIDE THE COMPANY AND EMPLOYEE DATA FOR THE COMPANY TO A COMPANY AND EMPLOYEE DATA SOURCE OPERATION 209 is maintained separately from the financial management system, e.g., the payroll management system.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

As noted above, in various embodiments, process 200 for providing a content based payroll compliance system is implemented as a Service Oriented Architecture (SOA) application. In these embodiments, the company and employee data source of PROVIDE THE COMPANY AND EMPLOYEE DATA FOR THE COMPANY TO A COMPANY AND EMPLOYEE DATA SOURCE OPERATION 209 is a company and employee data service, or data service, within the SOA application implementing process for providing a content based payroll compliance system.

In one embodiment, the company and employee data service of PROVIDE THE COMPANY AND EMPLOYEE DATA FOR THE COMPANY TO A COMPANY AND EMPLOYEE DATA SOURCE OPERATION 209 implements a REpresentational State Transfer (REST) Application/Program Interface (API) where data is transferred as either Extensible Markup Language (XML) data or JavaScript Object Notation (JSON) data.

In one embodiment, the company and employee data service of PROVIDE THE COMPANY AND EMPLOYEE DATA FOR THE COMPANY TO A COMPANY AND EMPLOYEE DATA SOURCE OPERATION 209 is stateless.

In one embodiment, once the company and employee data for a company and a region of OBTAIN COMPANY AND EMPLOYEE DATA FOR A COMPANY AND ONE OR MORE EMPLOYEES ASSOCIATED WITH THE COMPANY OPERATION 207 is stored in a database and a company and employee data source is provided access to the database and the company and employee data at PROVIDE THE COMPANY AND EMPLOYEE DATA FOR THE COMPANY TO A COMPANY AND EMPLOYEE DATA SOURCE OPERATION 209, process flow proceeds to PROVIDE A PAYROLL ENGINE, THE PAYROLL ENGINE BEING USED TO GENERATE REGIONAL PAYROLL DATA OPERATION 211.

In one embodiment, at PROVIDE A PAYROLL ENGINE, THE PAYROLL ENGINE BEING USED TO GENERATE REGIONAL PAYROLL DATA OPERATION 211, a payroll engine is provided for calculating, or running a payroll, and generating regionally optimized payroll data.

In one embodiment, the payroll engine of PROVIDE A PAYROLL ENGINE, THE PAYROLL ENGINE BEING USED TO GENERATE REGIONAL PAYROLL DATA OPERATION 211 is a content system that allows for the uploading and updating of the payroll jurisdiction metadata while the financial management system application is running, e.g., while the payroll management system is installed and running. Consequently, a user in a region not currently supported can create the required payroll jurisdiction metadata files and upload them and then have a payroll management system optimized for their region; not only for their use, but also for the use of anyone else in that region. As a result, a provider of a financial management system using process 200 for providing a content based payroll compliance system is provided the ability to focus and create the regionally optimized files without having to redeploy an application to gain support for a desired region.

As noted above, in one embodiment, process 200 for providing a content based payroll compliance system is implemented as a Service Oriented Architecture (SOA) application. In these embodiments, the payroll engine of PROVIDE A PAYROLL ENGINE, THE PAYROLL ENGINE BEING USED TO GENERATE REGIONAL PAYROLL DATA OPERATION 211 includes SOA related functions and modules such as, but not limited to, a caching service and an orchestration module/function, such as an orchestration module/function provided by Mulesoft™.

In one embodiment, once a payroll engine is provided for calculating, or running a payroll, and generating regionally optimized payroll data at PROVIDE A PAYROLL ENGINE, THE PAYROLL ENGINE BEING USED TO GENERATE REGIONAL PAYROLL DATA OPERATION 211, process flow proceeds to PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213.

In one embodiment, at PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213 the payroll engine of PROVIDE A PAYROLL ENGINE, THE PAYROLL ENGINE BEING USED TO GENERATE REGIONAL PAYROLL DATA OPERATION 211 is provided access to the payroll jurisdiction metadata for the region of OBTAIN PAYROLL JURISDICTION METADATA FOR A REGION OPERATION 203 and the company and employee data for the company and one or more employees associated with the company for the region of OBTAIN COMPANY AND EMPLOYEE DATA FOR A COMPANY AND ONE OR MORE EMPLOYEES ASSOCIATED WITH THE COMPANY OPERATION 207.

In one embodiment, at PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213 the payroll engine of PROVIDE A PAYROLL ENGINE, THE PAYROLL ENGINE BEING USED TO GENERATE REGIONAL PAYROLL DATA OPERATION 211 is provided access to the payroll jurisdiction metadata for the region of OBTAIN PAYROLL JURISDICTION METADATA FOR A REGION OPERATION 203 through the payroll calculation source of PROVIDE THE PAYROLL JURISDICTION METADATA FOR THE REGION TO A PAYROLL CALCULATION SOURCE, THE PAYROLL CALCULATION SOURCE HAVING ACCESS TO PAYROLL JURISDICTION METADATA ASSOCIATED WITH ONE OR MORE REGIONS OPERATION 205 and the company and employee data for the company and one or more employees associated with the company for the region of OBTAIN COMPANY AND EMPLOYEE DATA FOR A COMPANY AND ONE OR MORE EMPLOYEES ASSOCIATED WITH THE COMPANY OPERATION 207 through the company and employee data source of PROVIDE THE COMPANY AND EMPLOYEE DATA FOR THE COMPANY TO A COMPANY AND EMPLOYEE DATA SOURCE OPERATION 209.

As noted above, in various embodiments, process 200 for providing a content based payroll compliance system is implemented as a Service Oriented Architecture (SOA) application. In these embodiments, at PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213 the payroll engine of PROVIDE A PAYROLL ENGINE, THE PAYROLL ENGINE BEING USED TO GENERATE REGIONAL PAYROLL DATA OPERATION 211 is provided access to the payroll jurisdiction metadata for the region through the payroll calculation service, or calculation service, and the company and employee data for the company and one or more employees associated with the company for the region through the company and employee data service, or data service, within the SOA application implementing process 200 for providing a content based payroll compliance system.

In one embodiment, once the payroll engine of PROVIDE A PAYROLL ENGINE, THE PAYROLL ENGINE BEING USED TO GENERATE REGIONAL PAYROLL DATA OPERATION 211 is provided access to the payroll jurisdiction metadata for the region of OBTAIN PAYROLL JURISDICTION METADATA FOR A REGION OPERATION 203 and the company and employee data for the company and one or more employees associated with the company for the region of OBTAIN COMPANY AND EMPLOYEE DATA FOR A COMPANY AND ONE OR MORE EMPLOYEES ASSOCIATED WITH THE COMPANY OPERATION 207 at PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213, process flow proceeds to TRANSFORM THE COMPANY AND EMPLOYEE DATA INTO REGIONAL PAYROLL DATA FOR THE COMPANY FOR THE REGION USING THE PAYROLL JURISDICTION METADATA FOR THE REGION USING THE PAYROLL ENGINE OPERATION 215.

In one embodiment, at TRANSFORM THE COMPANY AND EMPLOYEE DATA INTO REGIONAL PAYROLL DATA FOR THE COMPANY FOR THE REGION USING THE PAYROLL JURISDICTION METADATA FOR THE REGION USING THE PAYROLL ENGINE OPERATION 215 the payroll engine of PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213 transforms the company and employee data for the region of OBTAIN COMPANY AND EMPLOYEE DATA FOR A COMPANY AND ONE OR MORE EMPLOYEES ASSOCIATED WITH THE COMPANY OPERATION 207 into regional payroll data using the payroll jurisdiction metadata for the region of OBTAIN PAYROLL JURISDICTION METADATA FOR A REGION OPERATION 203.

In one embodiment, at TRANSFORM THE COMPANY AND EMPLOYEE DATA INTO REGIONAL PAYROLL DATA FOR THE COMPANY FOR THE REGION USING THE PAYROLL JURISDICTION METADATA FOR THE REGION USING THE PAYROLL ENGINE OPERATION 215 the payroll engine of PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213 transforms the company and employee data for the region into regional payroll data using the payroll jurisdiction metadata for the region by linking the company and employee data to the corresponding region definition. In one embodiment, the regional payroll data is then generated, i.e., the regionally optimized payroll is run, for the company using the following basic approach:

1. Iterate through each employee;

2. Calculate the base pay;

3. Create an execution context;

4. Store each jurisdiction form within the context;

5. Store tables within the context;

6. Store constants within the context;

7. Iterate through the income phase wage items and call the calculation function with the execution context;

8. For each wage item, update the gross pay and current pay by adding the result of the calculation and add the result to the current paystub;

9. Iterate through the pre-tax phase wage items and call the calculation function with the execution context;

10. For each wage item, update the current pay by subtracting the result of the calculation and adding the result to the current paystub;

11. Iterate through the tax wage items and call the calculation function with the execution context.

12. For each wage item, add to the total tax amount and add the result to the current paystub.

13. Set the current pay to the gross pay from 7. less the total tax amount from 11;

14. Iterate through the post-tax wage items and call the calculation function with the execution context;

15. For each wage item, update the current pay by subtracting the result of the calculation and adding the result to the current paystub. The current pay at the end of this step is the final amount for the paycheck.

16. Iterate through the information wage items and call the calculation function with the execution context.

17. For each wage item, add the result to the current paystub.

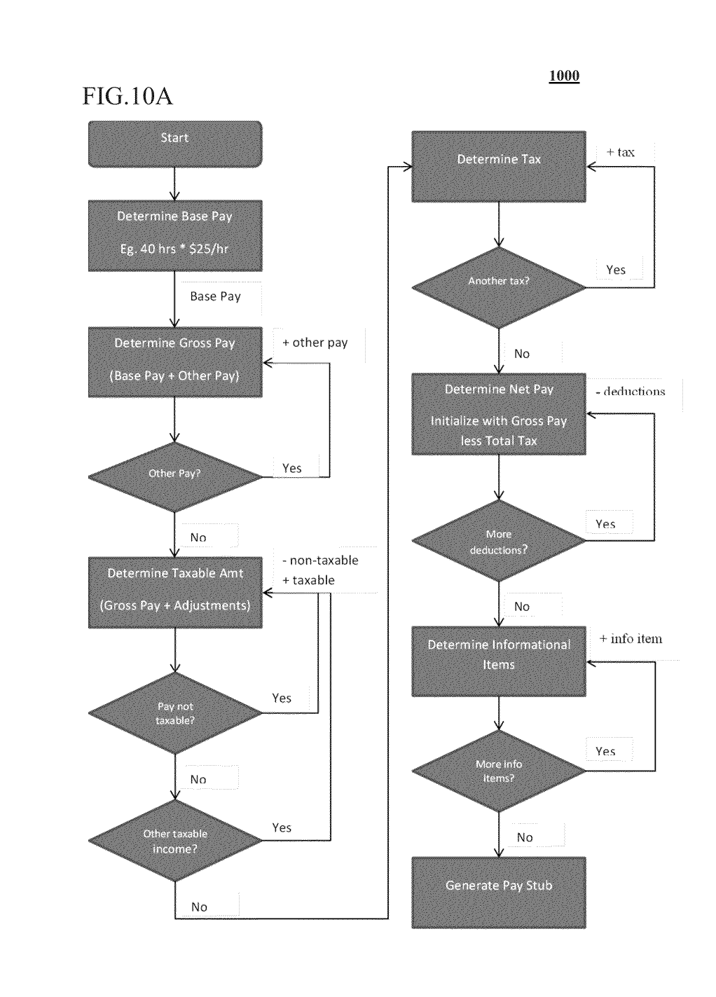

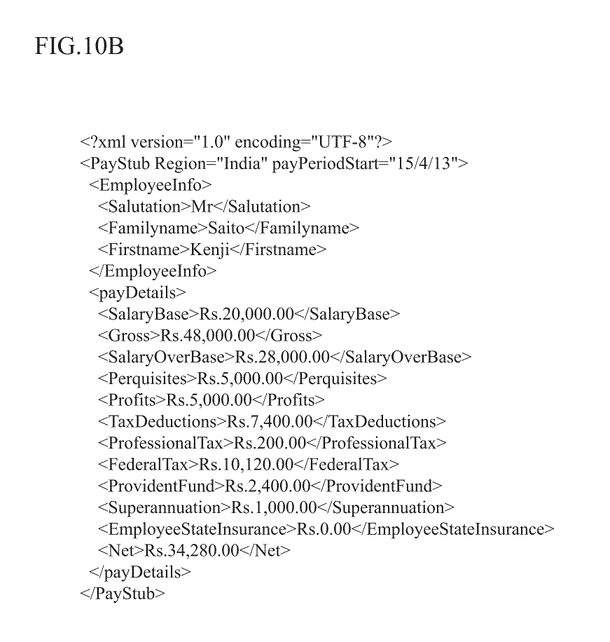

FIG. 10A is a flow chart showing one illustrative example of a process 1000 for generating the regional payroll data, i.e., running the regionally optimized payroll, for the company, in accordance with one embodiment.

FIG. 10B shows a resultant codified paystub generated in accordance with a specific example of one embodiment.

In one embodiment, once the payroll engine of PROVIDE THE PAYROLL JURISDICTION METADATA FOR THE REGION FROM THE PAYROLL CALCULATION SOURCE AND THE COMPANY AND EMPLOYEE DATA FOR THE COMPANY FROM THE COMPANY AND EMPLOYEE DATA SOURCE TO THE PAYROLL ENGINE OPERATION 213 transforms the company and employee data for the region of OBTAIN COMPANY AND EMPLOYEE DATA FOR A COMPANY AND ONE OR MORE EMPLOYEES ASSOCIATED WITH THE COMPANY OPERATION 207 into regional payroll data using the payroll jurisdiction metadata for the region of OBTAIN PAYROLL JURISDICTION METADATA FOR A REGION OPERATION 203 at TRANSFORM THE COMPANY AND EMPLOYEE DATA INTO REGIONAL PAYROLL DATA FOR THE COMPANY FOR THE REGION USING THE PAYROLL JURISDICTION METADATA FOR THE REGION USING THE PAYROLL ENGINE OPERATION 215, process flow proceeds to PROVIDE THE REGIONAL PAYROLL DATA FOR THE COMPANY FOR THE REGION TO A FINANCIAL MANAGEMENT SYSTEM OPERATION 217.

In one embodiment, at PROVIDE THE REGIONAL PAYROLL DATA FOR THE COMPANY FOR THE REGION TO A FINANCIAL MANAGEMENT SYSTEM OPERATION 217 the regional payroll data is provided to the financial management system, e.g., the payroll management system.

In one embodiment, once the regional payroll data is provided to the financial management system at PROVIDE THE REGIONAL PAYROLL DATA FOR THE COMPANY FOR THE REGION TO A FINANCIAL MANAGEMENT SYSTEM OPERATION 217, process flow proceeds to EXIT OPERATION 230.

In one embodiment, at EXIT OPERATION 230, process 200 for providing a content based payroll compliance system is exited to await new data.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

Using process 200 for providing a content based payroll compliance system discussed above, payroll jurisdiction metadata for one or more regions is obtained and maintained separate from the financial management system, e.g., the payroll management system. Then company and employee data for a company and one or more employees associated with the company is also obtained and maintained separate from the financial management system, e.g., the payroll management system. In one embodiment, the payroll jurisdiction metadata for the region and the employee data for the company are provided to a payroll engine where the company and employee data for the company is transformed into regional payroll data for the company for the region using the payroll jurisdiction metadata for the region. In one embodiment, the regional payroll data for the company for the region is only then provided to the financial management system, e.g., the payroll management system.

Consequently, process 200 for providing a content based payroll compliance system a payroll compliance system is provided where the calculations and rules required for a given region, such as a given municipality, city, county, state, or country, at a given time, are described entirely within a set of jurisdiction metadata files for the region that are created and maintained independently from the financial management system, e.g., a payroll management application. This allows for the addition of new regions, as well as the updating and maintaining of existing regions, without having to recompile or redeploy a codebase, or a new version of the payroll application or module.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for providing a content based payroll compliance system comprising the following, which when executed individually or collectively by any set of one or more processors perform a process including:
obtaining payroll jurisdiction metadata for a region;
providing the payroll jurisdiction metadata for the region to a payroll calculation source, the payroll calculation source having access to payroll jurisdiction metadata associated with one or more regions;
obtaining company and employee data for a company and one or more employees associated with the company;
providing the company and employee data for the company to a company and employee data source;
providing a payroll engine, the payroll engine being used to generate regional payroll data;
the payroll engine accessing the payroll jurisdiction metadata for the region from the payroll calculation source and the company and employee data for the company from the company and employee data source;
the payroll engine transforming the company and employee data into regional payroll data for the company for the region using the payroll jurisdiction metadata for the region; and
providing the regional payroll data for the company for the region to a financial management system.

2. The computing system implemented method for providing a content based payroll compliance system of claim 1 wherein the payroll jurisdiction metadata for a region includes a data, constants, and ordering file for the region and a calculation execution file for the region.

3. The computing system implemented method for providing a content based payroll compliance system of claim 2 wherein the data, constants, and ordering file for the region includes tables data for the region, constants data for the region, form definitions data for the region, and defined wage items data for the region.

4. The computing system implemented method for providing a content based payroll compliance system of claim 3 wherein the defined wage items for the region include one or more wage items selected from the group of wage items consisting of:
income items;
taxable deduction items;
non-taxable deduction items;
hours worked;
hourly rate;
salary; and
taxes withheld;

5. The computing system implemented method for providing a content based payroll compliance system of claim 4 wherein each wage item is assigned a payroll calculation phase category for the region.

6. The computing system implemented method for providing a content based payroll compliance system of claim 5 wherein the payroll calculation phase categories include at least one payroll calculation phase category selected from the group of payroll calculation phase categories consisting of:
income;
pre-tax;
tax;
post-tax; and
informational.

7. The computing system implemented method for providing a content based payroll compliance system of claim 3 wherein the calculation execution file for the region includes a payroll calculation function for each wage item for the region.

8. The computing system implemented method for providing a content based payroll compliance system of claim 1 wherein the payroll calculation source is a Service Oriented Architecture (SOA) calculation service.

9. The computing system implemented method for providing a content based payroll compliance system of claim 1 wherein the payroll calculation source is a SOA calculation service.

10. The computing system implemented method for providing a content based payroll compliance system of claim 1 wherein company and employee data is provided as EXtensible Markup Language (XML) data.

11. The computing system implemented method for providing a content based payroll compliance system of claim 1 wherein company and employee data is provided as JavaScript Object Notation (JSON) data.

12. The computing system implemented method for providing a content based payroll compliance system of claim 1 wherein the payroll engine transforms the company and employee data into regional payroll data for the company for the region using the payroll jurisdiction metadata for the region using an SOA orchestration service.

13. The computing system implemented method for providing a content based payroll compliance system of claim 1 wherein the financial management system is a payroll management system.

14. The computing system implemented method for providing a content based payroll compliance system of claim 1 wherein the financial management system is a web-based payroll management system.

15. The computing system implemented method for providing a content based payroll compliance system of claim 1 wherein the financial management system is a mobile payroll management system.

16. A computer program product for providing a content based payroll compliance system comprising:
a nontransitory computer readable medium;
and computer program code, encoded on the computer readable medium, comprising computer readable instructions which, when executed via any set of one or more processors, perform the following:
obtaining payroll jurisdiction metadata for a region;
providing the payroll jurisdiction metadata for the region to a payroll calculation source, the payroll calculation source having access to payroll jurisdiction metadata associated with one or more regions;
obtaining company and employee data for a company and one or more employees associated with the company;
providing the company and employee data for the company to a company and employee data source;
providing a payroll engine, the payroll engine being used to generate regional payroll data;
the payroll engine accessing the payroll jurisdiction metadata for the region from the payroll calculation source and the company and employee data for the company from the company and employee data source;
the payroll engine transforming the company and employee data into regional payroll data for the company for the region using the payroll jurisdiction metadata for the region; and
providing the regional payroll data for the company for the region to a financial management system.

17. The computer program product for providing a content based payroll compliance system of claim 16 wherein the payroll jurisdiction metadata for a region includes a data, constants, and ordering file for the region and a calculation execution file for the region.

18. The computer program product for providing a content based payroll compliance system of claim 17 wherein the data, constants, and ordering file for the region includes tables data for the region, constants data for the region, form definitions data for the region, and defined wage items data for the region.

19. The computer program product for providing a content based payroll compliance system of claim 18 wherein the defined wage items for the region include one or more wage items selected from the group of wage items consisting of:
income items;
taxable deduction items;
non-taxable deduction items;
hours worked;
hourly rate;
salary; and
taxes withheld;

20. The computer program product for providing a content based payroll compliance system of claim 19 wherein each wage item is assigned a payroll calculation phase category for the region.

21. The computer program product for providing a content based payroll compliance system of claim 20 wherein the payroll calculation phase categories include at least one payroll calculation phase category selected from the group of payroll calculation phase categories consisting of:
income;
pre-tax;
tax;
post-tax; and
informational.

22. The computer program product for providing a content based payroll compliance system of claim 18 wherein the calculation execution file for the region includes a payroll calculation function for each wage item for the region.

23. The computer program product for providing a content based payroll compliance system of claim 16 wherein the payroll calculation source is a Service Oriented Architecture (SOA) calculation service.

24. The computer program product for providing a content based payroll compliance system of claim 16 wherein the payroll calculation source is a SOA calculation service.

25. The computer program product for providing a content based payroll compliance system of claim 16 wherein company and employee data is provided as EXtensible Markup Language (XML) data.

26. The computer program product for providing a content based payroll compliance system of claim 16 wherein company and employee data is provided as JavaScript Object Notation (JSON) data.

27. The computer program product for providing a content based payroll compliance system of claim 16 wherein the payroll engine transforms the company and employee data into regional payroll data for the company for the region using the payroll jurisdiction metadata for the region using an SOA orchestration service.

28. The computer program product for providing a content based payroll compliance system of claim 16 wherein the financial management system is a payroll management system.

29. The computer program product for providing a content based payroll compliance system of claim 16 wherein the financial management system is a web-based payroll management system.

30. The computer program product for providing a content based payroll compliance system of claim 16 wherein the financial management system is a mobile payroll management system.

31. A system for providing a content based payroll compliance system comprising:
at least one processor; and
at least one memory coupled to the at least one processor, the at least one memory having stored therein instructions which when executed by any set of the one or more processors, perform a process for providing a content based payroll compliance system, the process for providing a content based payroll compliance system including:
obtaining payroll jurisdiction metadata for a region;
providing the payroll jurisdiction metadata for the region to a payroll calculation source, the payroll calculation source having access to payroll jurisdiction metadata associated with one or more regions;
obtaining company and employee data for a company and one or more employees associated with the company;
providing the company and employee data for the company to a company and employee data source;
providing a payroll engine, the payroll engine being used to generate regional payroll data;
the payroll engine accessing the payroll jurisdiction metadata for the region from the payroll calculation source and the company and employee data for the company from the company and employee data source;
the payroll engine transforming the company and employee data into regional payroll data for the company for the region using the payroll jurisdiction metadata for the region; and
providing the regional payroll data for the company for the region to a financial management system.

32. The system for providing a content based payroll compliance system of claim 31 wherein the payroll jurisdiction metadata for a region includes a data, constants, and ordering file for the region and a calculation execution file for the region.

33. The system for providing a content based payroll compliance system of claim 32 wherein the data, constants, and ordering file for the region includes tables data for the region, constants data for the region, form definitions data for the region, and defined wage items data for the region.

34. The system for providing a content based payroll compliance system of claim 33 wherein the defined wage items for the region include one or more wage items selected from the group of wage items consisting of:
income items;
taxable deduction items;
non-taxable deduction items;
hours worked;
hourly rate;
salary; and
taxes withheld;

35. The system for providing a content based payroll compliance system of claim 34 wherein each wage item is assigned a payroll calculation phase category for the region.

36. The system for providing a content based payroll compliance system of claim 35 wherein the payroll calculation phase categories include at least one payroll calculation phase category selected from the group of payroll calculation phase categories consisting of:
income;
pre-tax;
tax;
post-tax; and
informational.

37. The system for providing a content based payroll compliance system of claim 33 wherein the calculation execution file for the region includes a payroll calculation function for each wage item for the region.

38. The system for providing a content based payroll compliance system of claim 31 wherein the payroll calculation source is a Service Oriented Architecture (SOA) calculation service.

39. The system for providing a content based payroll compliance system of claim 31 wherein the payroll calculation source is a SOA calculation service.

40. The system for providing a content based payroll compliance system of claim 31 wherein company and employee data is provided as EXtensible Markup Language (XML) data.

41. The system for providing a content based payroll compliance system of claim 31 wherein company and employee data is provided as JavaScript Object Notation (JSON) data.

42. The system for providing a content based payroll compliance system of claim 31 wherein the payroll engine transforms the company and employee data into regional payroll data for the company for the region using the payroll jurisdiction metadata for the region using an SOA orchestration service.

43. The system for providing a content based payroll compliance system of claim 31 wherein the financial management system is a payroll management system.

44. The system for providing a content based payroll compliance system of claim 31 wherein the financial management system is a web-based payroll management system.

45. The system for providing a content based payroll compliance system of claim 31 wherein the financial management system is a mobile payroll management system.
